(19) United States
(12) Patent Application Publication
(10) Pub. No.: US 2007/0233566 A1
(43) Pub. Date: Oct. 4, 2007

(54) SYSTEM AND METHOD FOR MANAGING NETWORK-BASED ADVERTISING CONDUCTED BY CHANNEL PARTNERS OF AN ENTERPRISE

(76) Inventors: Dema Zlotin, La Jolla, CA (US); Curt Nelson, Julian, CA (US); Brian Bartell, San Diego, CA (US)

Correspondence Address: COOLEY GODWARD KRONISH LLP;ATTN: Patent Group, Suite 500, 1200 - 19th Street, NW, Washington, DC, 20036-2402, US

(21) Appl. No.: 11/678,002

(22) Filed: Feb. 22, 2007

Related U.S. Application Data
(60) Provisional application No. 60/778,594, filed on Mar. 1, 2006.
(60) Provisional application No. 60/823,615, filed on Aug. 25, 2006.
(60) Provisional application No. 60/868,705, filed on Dec. 5, 2006.
(60) Provisional application No. 60/868,702, filed on Dec. 5, 2006.

(51) Int. Cl. G06Q 30/00

(52) U.S. Cl. 705/14

(57) ABSTRACT

The invention generally relates to a system and method for facilitating cooperative search engine marketing among business entities and their respective channel partners. Embodiments of the invention permit such business enterprises to easily create and distribute approved advertisements and campaign templates, allocate and track the usage of market development funds, monitor the results of sponsored search advertising campaigns instituted by their channel partners, and streamline the reimbursement process for market development funds (MDF). The enterprise may begin the process by creating “ready-made” advertisements and keyword lists with pre-approved content, which helps the enterprise protect brand identity and ensure consistent messaging while making the process of initiating a paid search campaign much easier for the channel partner.

### PRIORITY

The present application claims priority to U.S. provisional application no. 60/778,594 entitled “System and Method for Managing Network-Based Advertising Conducted by Channel Partners of an Enterprise,” filed on Mar. 01, 2006.

### CROSS-REFERENCE TO RELATED APPLICATIONS

This application relates to and incorporates by reference Provisional Application No. 60/778,594, entitled “System and Method for Managing Network-Based Advertising Conducted by Channel Partners of an Enterprise,” filed on Mar. 1, 2006, Provisional Application No. 60/823,615, entitled, “System and Method for Aggregating Online Advertising Data and Providing Advertiser Services,” filed on Aug. 25, 2006, Provisional Application No. 60/868,705, entitled “System and Method for Measuring the Effectiveness of an Online Advertisement Campaign,” filed on Dec. 5, 2006, Provisional Application No. 60/868,702, entitled “Centralized Web-Based Software Solution for Search Engine Optimization,” filed on Dec. 5, 2006.

### FIELD OF THE INVENTION

The invention generally relates to systems and methods for managing search engine marketing campaigns. In particular, but not by way of limitation, the invention relates to systems and methods for facilitating cooperative search engine marketing among business entities and their respective channel partners.

### BACKGROUND OF THE INVENTION

Internet sites providing search services have provided advertisers with the opportunity for the placement of advertisements targeted to specific user interests based upon keywords within a search query or phrase entered into the applicable search engine. Typically, the Internet search engine generates, in response to the search query, a listing of hyperlinked pages from the World Wide Web (“web pages”) capable of being accessed by the user. While Internet sites hosting search engines may organize the listing of web pages using algorithms responsive to the keywords in the search query, a “sponsored search” application may be executed in parallel with operation of the search engine in order to generate a second set of listings featuring advertisers which have contracted with the Internet site for placement among such listings. These listing results may be called “sponsored links” or the like.

Advertisers contracting for placement within the results generated by sponsored search applications may be required to pay for each click-through referral generated through such sponsored search results. Placement within the results is generally determined in accordance with a competitive bidding process, pursuant to which advertisers select and bid upon those search keywords perceived to be most pertinent to the products or services offered through their web site. Those advertisers bidding higher for particular keywords are generally placed correspondingly “higher” or otherwise more favorably in the sponsored search results corresponding to such keywords.

Large organizations such as national retailers, manufacturers and publishers have attempted to exploit the advertising opportunities afforded by sponsored search applications. Such organizations, along with their distributors and other promoters (collectively, “channel partners”), have allocated marketing funds for use in advertising through sponsored search applications. Although such “search engine marketing” campaigns have paid dividends, inefficiencies have arisen when such campaigns are conducted by multiple channel partners of an organization across diverse markets and geographic regions. For example, brand integrity and message consistency may suffer when numerous channel partners independently undertake concurrent search engine marketing campaigns. In addition, competition among such channel partners in connection with bidding upon keywords auctioned by sponsored search applications can lead to inefficient expenditure of marketing resources.

Historically, some large commercial enterprises have also offered market development funds (MDF) as a benefit to their most valued channel partners. Most commonly, market development funds are distributed to channel partners either to reimburse marketing costs or to “match” the dollars spent by the channel partner on both conventional (e.g., print media) and Internet-based forms of advertising. The objective of these funds has been to generate demand (sales and revenue) by paying for specific marketing programs that benefit both parties. The allocation and usage of these funds is believed to offer a greater return on marketing investment than the return independently realizable by each organization.

Unfortunately, the processes attendant to implementation of MDF programs have traditionally been complex and cumbersome. For the organization offering the market development funds, tracking and analyzing the effectiveness of such funds has proved particularly difficult. On the other hand, channel partners are burdened with the tasks of requesting allocations, tracking results, reporting leads, and claiming reimbursement for the spending. As a consequence, a portion of available market development funds tend to remain unallocated, which means that available marketing resources are not utilized. Such burdens currently exist with respect to both search engine marketing campaigns and more traditional advertising programs.

### SUMMARY OF THE INVENTION

Exemplary embodiments of the invention that are shown in the drawings are summarized below. These and other embodiments are more fully described in the Detailed Description section. It is to be understood that there is no intention to limit the invention to the forms described in this Summary of the Invention or in the Detailed Description. One skilled in the art can recognize that there are numerous modifications, equivalents and alternative constructions that fall within the spirit and scope of the invention as expressed in the claims.

The invention can provide a system and method for facilitating cooperative search engine marketing among business entities and their respective channel partners. In one exemplary embodiment, the invention may include a method, or system configured to perform such a method, for creating an online advertisement for inclusion within results produced by sponsored search applications. During the method, an advertising template developed by a business entity is selected. Upon the selection of the template, advertising information for inclusion within the advertisement and consistent with the advertising template is selected. Additionally, a set of pre-approved, associated keywords for the advertisement will be presented and allow the channel partner to bid via selection of a keyword processed by the one or more sponsored search applications. Upon making such selections, a representation of the advertisement is presented. Once a selectiong is made, the advertisement is scheduled to run on one or more sponsored search applications. As these advertisements run, results and reports are consolidated and made available to both business entities and their respective channel partners.

In another exemplary embodiment, the invention may include a method, or a system configured to perform such a method, for generating an advertising template capable of being utilized by a channel partner to create an advertisement that is used within one or more sponsored search applications. During the method, one or more template attributes of the advertising template are selected. Upon the selection of template attributes, advertising content for incorporation into the advertising template and consistent with the one or more template attributes is received. Selections of keywords processed by one or more sponsored search applications and bid information associated with the keywords are then received. After incorporating the selections of the keywords and the bid information into the advertising template, the method displays a representation of the advertising template. Once approved, the advertisement is scheduled to run on one or more sponsored search applications. As these advertisements run, results and reports are consolidated and made available to both business entities and their respective channel partners.

Other embodiments may include servers or the like that perform operations consistent with or similar to the methods summarized above.

### BRIEF DESCRIPTION OF THE DRAWINGS

Various objects and advantages and a more complete understanding of the invention are apparent and more readily appreciated by reference to the following Detailed Description and to the appended claims when taken in conjunction with the accompanying Drawings wherein:

FIG. 1 illustrates an exemplary networked environment within which the cooperative search engine marketing system and method of the invention may be practiced;

FIG. 2 shows a process flow diagram representative of the flow of information and movement of funds among and between a search engine marketing (SEM) service provider and other system elements of FIG. 1 in a manner consistent with the invention;

FIG. 3 is a flow chart representative of an exemplary sequence of actions for generating an advertising template capable of being used by channel partners of an enterprise in creating advertisements for use in one or more sponsored search applications;

FIGS. 4-7 illustrate a sequence of screen shots of exemplary graphical interfaces generated by an SEM service provider through which a business enterprise may provide template information in accordance with the flow chart of FIG. 3;

FIG. 8 illustrates a hierarchical site map of the various user interfaces capable of being presented by an SEM service provider to a business enterprise during the process of creating advertising templates and other operations;

FIG. 9 is a flow chart representative of an exemplary sequence of actions performed by a channel partner in creating an advertisement based upon an advertising template defined by a business enterprise;

FIGS. 10-13 illustrate a sequence of screen shots of exemplary graphical interfaces generated by an SEM service provider through which a channel partner may furnish the partner-specific information in accordance with the flow chart of FIG. 9;

FIG. 14 illustrates a hierarchical site map of the various user interfaces capable of being presented by an SEM service provider to a channel partner;

FIGS. 15-17 depict screen shots of exemplary user interfaces generated by an SEM service provider through which campaign status and performance information may be conveyed to a business enterprise or one of its channel partners;

FIG. 18 illustrates a generalized site map representative of those user interfaces which may be accessed by a business enterprise in order to accomplish a variety of tasks relating to, for example, creation of partner and template definitions, viewing and editing of templates and lists of partners participating in various campaigns, and management of search engine accounts;

FIG. 19 illustrates a generalized site map representative of those user interfaces which may be accessed by a channel partner in order to accomplish a variety of tasks relating to, for example, setting up an account, creating, viewing and editing advertisements generated using a template(s) provided by a business enterprise, viewing and managing billing-related information, and generating reports;

FIG. 20 is a high-level diagram of exemplary server infrastructure operated by an SEM service provider;

FIG. 21 illustrates a task flow diagram representative of operations associated with the “lifespan” of an advertisement created by an SEM service provider for a channel partner;

FIG. 22 shows an exemplary class design of an object-oriented implementation of a search engine ad manager subsystem;

FIG. 23 is a diagram representative of the communication occurring between an SEM service provider and a search engine;

FIG. 24 illustrates a schema representative of an exemplary implementation of an ads subsystem;

FIG. 25 illustrates a schema representative of an exemplary implementation of the a metrics subsystem; and

FIG. 26 shows a schema representative of an exemplary implementation of a search engine ad manager subsystem.

### DETAILED DESCRIPTION OF EMBODIMENTS OF THE INVENTION

The invention generally relates to a system and method for facilitating cooperative search engine marketing among business entities and their respective channel partners. The invention may also generally relate to applications outside of search engine marketing or Internet-based marketing, including for example only, television, radio, and print media marketing.

Embodiments of the invention permit business enterprises to easily create and distribute approved advertisements and campaign templates, allocate and track the usage of market development funds, and monitor the results of sponsored search advertising campaigns instituted by their channel partners. The enterprise may begin the process by creating one or more “ready-made” advertisements for selection by a channel partner. For example, such advertisements may include text-, image-, video-, and/or radio-based advertistments. The enterprise may also create one or more listings of approved targets that determine when a selected advertisement will run. For example, targets may include search engine keywords, websites, geographic locations (e.g., zip codes, cities, states, neighborhoods, etc.), demographic categories (e.g., age, gender, race, shopping history, etc.), and time periods, among others. As with advertisements, the targets may be selected by a channel partner.

For example, the “ready-made” advertisements and listings of targets help the enterprise protect brand identity and ensure consistent messaging while making the process of initiating a marketing campaign (e.g, a paid search campaign) much easier for the channel partner. Reimbursement of market development funds (MDFs) are also streamlined using this method.

In particular, channel partners may initiate a paid search advertising campaign through an efficient, multi-step process. First, a channel partner selects one of the pre-approved message templates based on such attributes as industry, product, region and language. Next, the partner populates the template with partner-specific details and chooses from a list of pre-approved targets (e.g., keywords for which bid price constraints will be submitted to one or more sponsored search applications, wherein the bid price constraints may include an upper bound, a lower bound, an MDF value, an actual bid amount, or any other constraints appreciated by one of skill in the art for optimizing a bid price associated with a keyword). The partner then specifies a start date and budget for the paid search campaign, and finally activates the campaign. Costs accrued and traffic to the web site of the partner generated by the campaign are monitored upon its activation until its conclusion.

Although several embodiments are described herein with respect to listing keywords as targets, one of skill in the art will appreciate alternative embodiments where other types of targets are used in addition to or in place of keywords. For example, a listing of websites would enable a channel partner to control the placement of a particular advertisement at selected websites. Under these circumstances an advertisement pertaining to diapers could be configured to only appear on www.new-borns.com. Likewise, a listing of demographic categories would enable a channel partner to direct an advertisement pertaining to diapers to new parents.

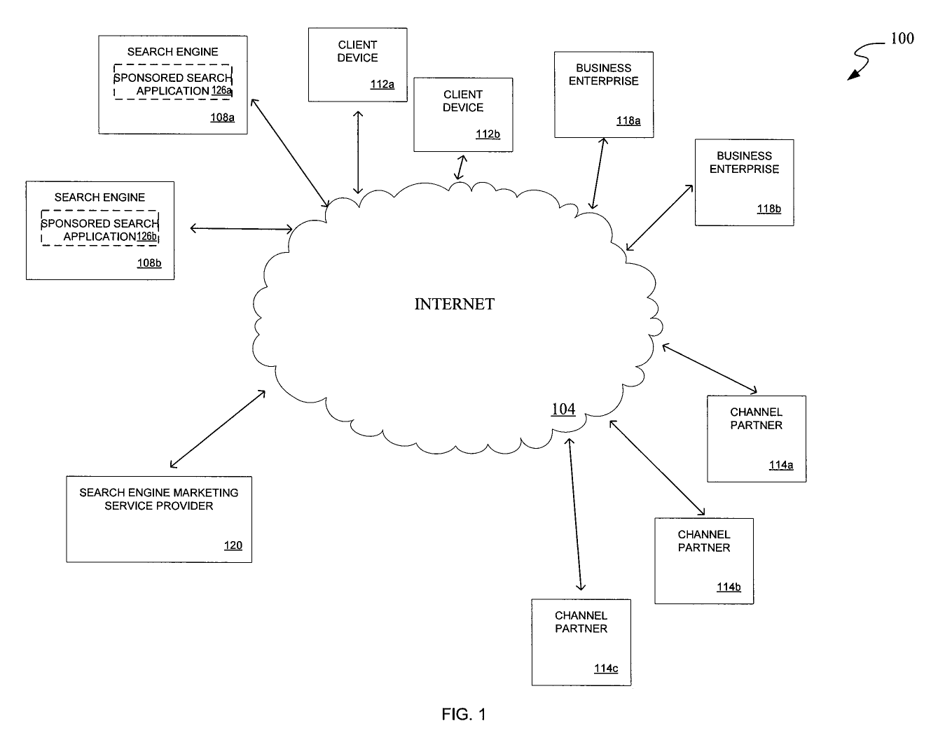

FIG. 1 illustrates an exemplary networked environment 100 within which the cooperative search engine marketing system and method of the invention may be practiced. The environment 100 includes a network 104, such as the Internet, capable of providing communication between the various client and server devices described hereinafter. As shown in FIG. 1, included among these devices are search engines 108 accessible by client devices 112 operated by consumers, channel partners 114 of business enterprises 118, and a search engine marketing (SEM) service provider 120 configured in accordance with the invention. As those skilled in the art will appreciate, various intermediary network routing and other elements between the Internet 104 and the devices depicted in FIG. 1 have been omitted for the sake of clarity. Such intermediary elements may include, for example, the public-switched telephone network (PSTN), gateways or other server devices, and other network infrastructure provided by Internet service providers (ISPs).

Referring again to FIG. 1, each search engine 108 is typically comprised of at least a web server and at least one associated database. This database is used in connection with the generation of web pages, rendered by the web browser of the user's client device 112, that contain the results of searches requested by the user. The contents of the database typically include, among other things, the results accumulated by one or more “spider” (or crawler) programs disposed to search the web and return content for the database to store and track. The database may also include advertisements provided by third party advertisers through a web interface of a sponsored search application 126 for use by such application 126 in a conventional manner. As is described below, certain of these advertisements may also be provided by a search engine marketing service provider 120 on behalf of the channel partners 114.

Although the embodiments herein are described with reference to advertising effected through search engines, it should be understood that the teachings of the invention are equally applicable to other forms of advertising. For example, embodiments of the invention may also be practices within the context of various pay-per-click (PPC) and other online advertising venues (e.g., the Vibrant Media content network, and banner advertising networks such as that operated by DoubleClick).

Each client device 112 may execute a web browser through which search terms may be entered by the user via a search page representation provided by a search engine 108. Upon sending the search terms entered by the user of the client device 112 to the search engine 108, the search engine 110 typically returns a plurality of search results. The search results generally include hyperlinks to web pages hosted by the web sites of third parties, thereby enabling the user to view information from these web pages through the web browser executing on the user's client device 112. The search results may include so-called sponsored search results, or “sponsored links”, which are generated by the sponsored search application 126 of the applicable search engine 108 based upon the search terms used in the submitted search query. As is known, search engines 108 often auction the search terms processed by the sponsored search application 126. In this way the owners of web sites (e.g., channel partners 114) may bid for position within the list of sponsored links generated by the sponsored search application 126. The links included within this list of sponsored links generally incorporate information permitting the search engine 108 to discern that the link was selected from a web page generated by the sponsored search application 126. Such information enables the search engine 110 to track user traffic generated through the sponsored search application 126 and appropriately charge the advertisers associated with the sponsored links produced by the sponsored search application 126.

The SEM service provider 120 operates one or more servers capable of Internet-based communication with each business enterprise 118, their respective channel partners 114, and the search engines 108. As is discussed below, the SEM service provider 120 enables channel partners 114 to select, bid on, and run advertisements through sponsored search applications 126 that have been pre-approved by the business enterprises 118 with which the channel partners 114 are respectively affiliated. The SEM service provider 120 also permits business enterprises 118 to easily create advertising templates that may be readily customized by their channel partners 114, and distributes the completed advertisements among the sponsored search applications 126 selected by the channel partner 114. Since channel partners 114 of an enterprise 118 also submit bids for keywords with respect to the various sponsored search applications 126 via the SEM service provider 120, the enterprise 118 may limit the number of its channel partners 114 permitted to compete for each keyword and may limit the maximum allowable bid for each of those channel partners 114. As such, the enterprise 118 may place bid constraints (e.g., lower bounds, upper bounds, MDF values, actual bid amounts, etc.) on the bids for each channel partner 114. In one embodiment, the limited number of channel partners 114 may be comprised of different channel partners 114 during two separate instances of time. In this manner, the SEM service provider 120 may allow a first group of channel partners 114 to compete/bid for a keyword during a first period of time, and then may allow a second group of channel partners 114 to compete/bid for the same keyword during a second period of time different than the first period of time. Additionally, the SEM service provider 120 facilitates the allocation and tracking of marketing funds/market development funds (MDFs) disbursed from enterprises 118 to their respective channel partners 114.

The SEM service provider 120 further enables enterprises 118 to view metrics relating to the performance of sponsored advertisements run by their channel partners 114. In this regard the reports provided by the SEM service provider to the participating business enterprises 118 and channel partners 114 may be generated based upon various criteria of interest. For example, such reports may be compiled, with respect to each search engine, as a function of those keyword(s) in search queries submitted to the search engine which result in the generation of search engine advertisements through which visitors are linked to the web site of the applicable channel partner 114. It is a feature of embodiments of the invention that the metrics within such reports enable the effectiveness of SEM strategies to be monitored and compared in order to quickly identify areas requiring action. Moreover, such reports also facilitate the tracking of keywords, campaigns and results across multiple channel partners, ad templates, industry segments and product lines, and efficiently allow channel partners to claim for MDF reimbursement from the enterprise.

As is discussed below, in exemplary embodiments the SEM service provider 120 interfaces with publicly accessible application programming interfaces (APIs) of the search engines 108 in connection with carrying out the methods of the invention. Through these APIs, the SEM service provider 120 obtains access to information of interest to participating channel partners 114 and sponsoring business enterprises 118 in connection with search engine advertising campaigns initiated by such channel partners 114 and business enterprises 118. Such information may include, for example, statistics relating to visits to the channel partner 114/business enterprise 118 web site (i.e., “impressions”) via hyperlinks selected in connection with execution of the advertising campaign through a search engine 108. Other relevant information may relate to the number of “click throughs”, actual sales or other lead generation activities occurring through the web site of the channel partner 114/business enterprise 118 as a result of the campaign.

The API-based information may be used by the business enterprise 118 to determine its return on advertising spent (ROAS), which is equivalent to dividing the difference between revenue associated with advertising by the business enterprise 118 and the cost of such advertising by the cost of advertising. The resultant ROAS may be used as a benchmark for determining an optimal contribution (i.e., an optimal amount of marketing funds/MDFs) given to a channel partner 114 for use in the channel partner's advertisement campaign. For example, if the business entity 118 achieves an ROAS of N % on its own advertising campaign and additionally receives a royalty return of X % on sales by one or more channel partners 114, it would be economically beneficial to the business entity 118 to contribute to the advertising campaign(s) of the one or more channel partners 114 if the royalties resulting from the contribution maintain an ROAS of N % or better. In the following equation, R represents the royalty percentage on sales by one or more channel partners 114, C represents an optimal contribution by the business enterprise 118, ROAS represents the ROAS of the business enterprise 118 prior to making C, and S represents expected or desired sales resulting from C. An optimal contribution amount C with respect to an expected amount of sales S can be calculated by:

$$Equation 1 \text{:} C \leq \frac{R * S}{ROAS + 100 \%}$$

The SEM service provider 120 may use Equation 1 (or variations thereof) to make any number of determinations as to whether a business enterprise 118 should contribute to an advertising campaign of a channel partner 114 in order to increase the overall revenue of the business enterprise 118 due to royalties. For example, if for a given keyword the channel partner 114 ranks third in a paid search listing and a competitor of the business enterprise 118 ranks second, the SEM service provider 120 may calculate an optimal contribution for expected sales resulting from placement in the second position of the paid search listing. The business enterprise 118 may choose, based on Equation 1, to give the optimal contribution to the channel partner 114 in order to assist the channel partner 114 in outbidding the competitor for placement in the second position of the paid search listing. The contribution may be conditioned on the channel partner 114 complying with certain expectations of the business enterprise 118, including maximum and minimum bid amounts, and use of specified advertisement templates, among others. As an additional benefit to the business enterprise 118 other than increased revenue, the contribution effectively allows the business enterprise 118 to strategically control the bidding on of certain keywords so as to avoid undesired competition between channel partners 114 and the business enterprise 118.

Alternatively, the SEM service provider 120 may allow a channel partner 114 to calculate a desired contribution based on expected sales for a target position in a paid search listing. Upon determining the calculated contribution, the channel partner 114 may contact business enterprises 118 with which the channel partner 114 is affiliated and solicit the contribution.

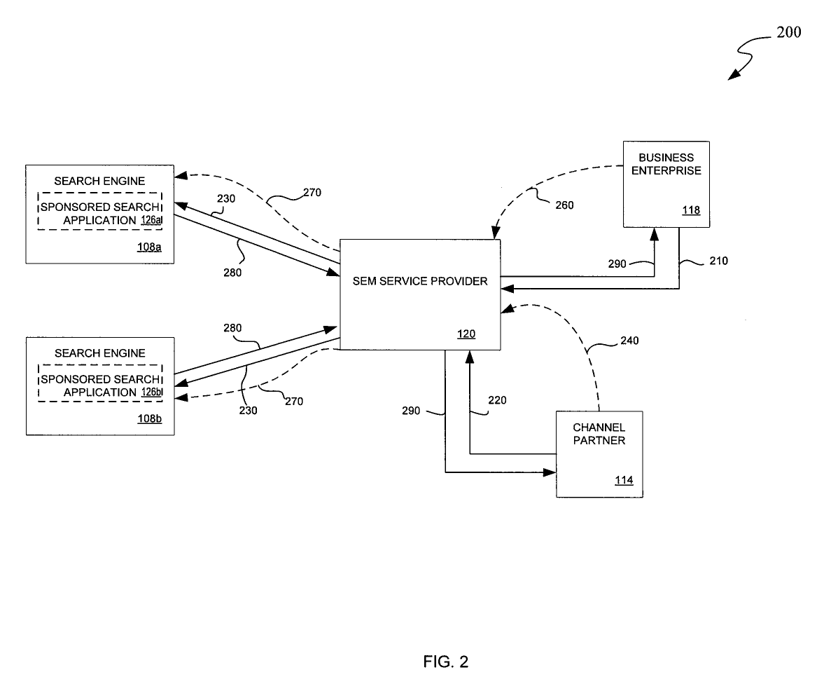

Turning now to FIG. 2, there is shown a process flow diagram 200 representative of the flow of information and movement of funds among and between the search engine marketing (SEM) service provider 120 and the other system elements of FIG. 1 in a manner consistent with the invention. As shown in FIG. 2, an enterprise 118 may begin the process by providing advertisement content and other information to the SEM service provider 120 sufficient to enable it create one or more advertising templates for use by the channel partners 114 of the enterprise (stage 210). This information will also typically include one or more lists of keywords which may be bid upon by the channel partners 114, and optionally a maximum bid amount for each keyword. As mentioned above, the SEM service provider 120 also permits business enterprises 118 to easily create advertising templates capable of being customized by the channel partners 114. To this end, each channel partner 114 provides the SEM service provider 120 with a selection of one of the advertising templates approved by the enterprise 118 and customization information specific to the partner for insertion into the template (stage 220). During this stage the channel partner 114 will also generally specify, with respect to each sponsored search application of interest to the channel partner 114, a start date and budget for the advertisement being created and bids for specific keywords. The SEM service provider 120 then distributes the advertisement to each sponsored search application selected to run the advertisement (stage 230).

Referring again to FIG. 2, in one implementation each channel partner 114 “prepays” the SEM service provider 120 an amount based upon the budgeted amount of the advertising campaign chosen by the channel partner (stage 240). This prepayment may be effected using conventional means (e.g., via a credit card or PayPal account, or through an electronic funds transfer). In an exemplary embodiment the amount of the prepayment required by a channel partner 114 is computed by the SEM service provider 120 using information obtained from the enterprise 118 sponsoring the advertising campaign of the channel partner 114. For example, if a channel partner 114 budgets $100,000 for an advertisement campaign, upon receiving the particulars of the campaign the SEM service provider 120 queries the applicable enterprise 118 to determine the amount, if any, of market development funds available to the channel partner 114 in connection with the campaign. If in the present example the enterprise 118 indicates that the channel partner 114 is entitled to matching contributions in the amount of 35% from the enterprise 118, then the SEM service provider 120 will request a prepayment of at least $65,000 from the channel partner 114 (e.g., via a credit card transaction). The SEM service provider 120 may then automatically distribute the campaign advertisements among the applicable search engines 108. In addition, the SEM service provider 120 may also invoice the applicable enterprise 118 in an amount comprised of the sum of the matching funds pledged to the channel partner 114 and any fee charged for use of the services provided by the SEM service provider 120. The business enterprise 118 then forwards funds corresponding to the invoiced amount to the SEM service provider 120 (stage 260), which enables the SEM service provider 120 to pay the search engines 108 for the advertisements run on behalf of the channel partner 114 (stage 270).

In other embodiments, funds transfer may occur directly between and among the applicable enterprise, associated search engine(s) and channel partner(s). That is, funds would not be transferred from the channel partner 114 to the SEM service provider 120, nor would the provider 120 deposit funds into financial accounts of the search engines 108 on behalf of one or more channel partners 114 of an enterprise. In these embodiments the SEM service provider 120 could nonetheless continue to provide accounting or other services to facilitate the transfer of funds between enterprise, channel partner and search engine. For example, the SEM service provider could continue to provide a mechanism to determine the extent, if any, of market development funds of a given enterprise that is available to a particular channel partner 114. It should be understood that in certain cases a business enterprise may elect to establish a co-marketing program in which it agrees to pay all or substantially all of the relevant costs to participating channel partners, and that various embodiments of the invention are equally applicable to this circumstance. In alternative embodiments approval and payment for advertising campaigns may be effected using purchase orders or similar approaches.

Once campaigns involving advertisements of the channel partners 114 have been initiated by the search engines 108, status and performance information is provided to the SEM service provider 120 through publicly accessible application programming interfaces (APIs) (stage 280). The SEM service provider 120 may then generate, based upon this information from the search engines 108, reports and other metrics relating to these advertising campaigns for viewing by the business enterprise 118 and channel partner 114 (stage 290).

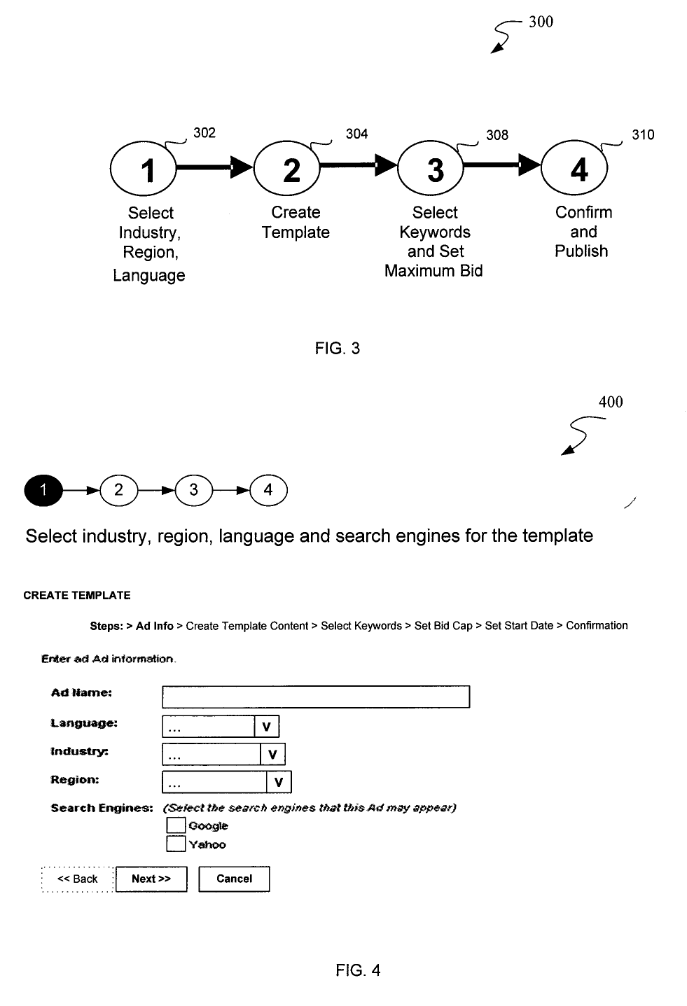

FIG. 3 is a flow chart 300 representative of an exemplary sequence of actions for generating an advertising template capable of being used by channel partners 114 of an enterprise 118 in creating advertisements for use in one or more sponsored search applications. In a stage 302, the business enterprise 118 selects a number of attributes or parameters for the advertising template including, for example, industry, region and language. These attributes constrain which partners qualify to advertise using the given template. During this stage the business enterprise 118 may also specify the set of one or more search engines to which advertisements developed for the channel partners 114 of the enterprise based upon the template may be distributed. The enterprise 118 then provides at least textual advertising content for incorporation into the template (stage 304). Next, the enterprise 118 selects keywords to be bid upon by channel partners 114 creating advertisements using the template and optionally specifies a maximum bid for each keyword (with respect to each of one or more sponsored search applications) (stage 308). Finally, the enterprise 118 selects start/end dates during which advertisements based upon the template may be run by channel partners 114, and provides confirmation that the content of the completed template displayed to the enterprise 118 is correct (stage 310). Once such confirmation is provided, the SEM service provider 120 electronically publishes or otherwise makes available the completed template to the channel partners 114 of the enterprise and permits them to create customized advertisements in the manner described below.

Attention is now directed to FIGS. 4-7, which illustrate a sequence of screen shots of exemplary graphical interfaces generated by the SEM service provider 120 through which a business enterprise 118 may provide the template information described with reference to the flow chart 300 (FIG. 3).

Turning now to FIG. 4, there is shown a screen shot of an exemplary graphical interface 400 through which the enterprise 118 may provide information relating to various attributes of the template. In particular, the interface 400 includes drop-down boxes for specifying the language, industry, and region applicable to the template. A text box is provided for inserting a name for the template. In addition, check boxes enable specification of the search engines 108 in which advertisements generated using the template may appear.

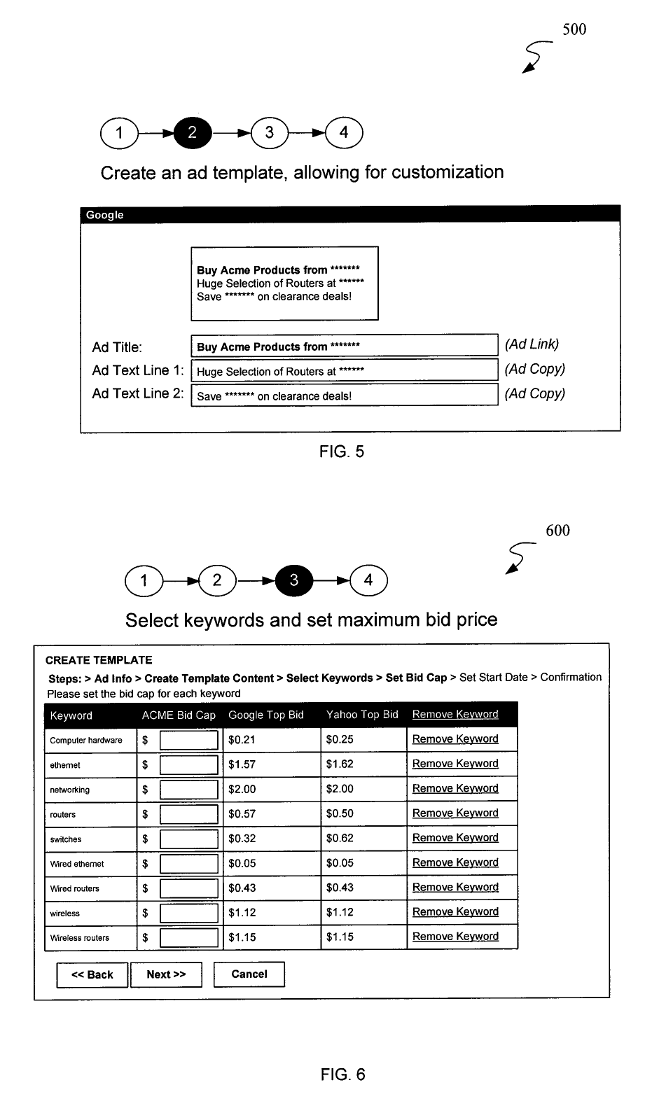

FIG. 5 shows a screen shot of an exemplary graphical user interface 500 configured to accept textual content from the enterprise 118 corresponding to a particular advertisement. A first text box, labeled “Ad Title:”, is provided for receiving a title for the advertisement. For example, in the example of FIG. 5 the enterprise 118 has entered a title of “Buy Acme Routers from ********” where the character string “********” is replaced with customizing information unique to a channel partner 114 when the template is used by the channel partner 114 to create a specific advertisement. Other text boxes are provided for enabling the enterprise 118 to enter the remaining textual content of the advertisement.

Referring to FIG. 6, a screen shot of an exemplary user interface 600 generated by the SEM service provider 120 includes a column of text boxes under the heading “ACME Bid Cap” through which the business enterprise 118 may enter a maximum bid associated with each of a list of keywords. In the representation of FIG. 6, each of these listed keywords has been previously selected by the enterprise 118 for association with the template being created, and each may be removed. As is also indicated by FIG. 6, one or more of the search engines 108 also furnishes a current highest bid associated with each keyword.

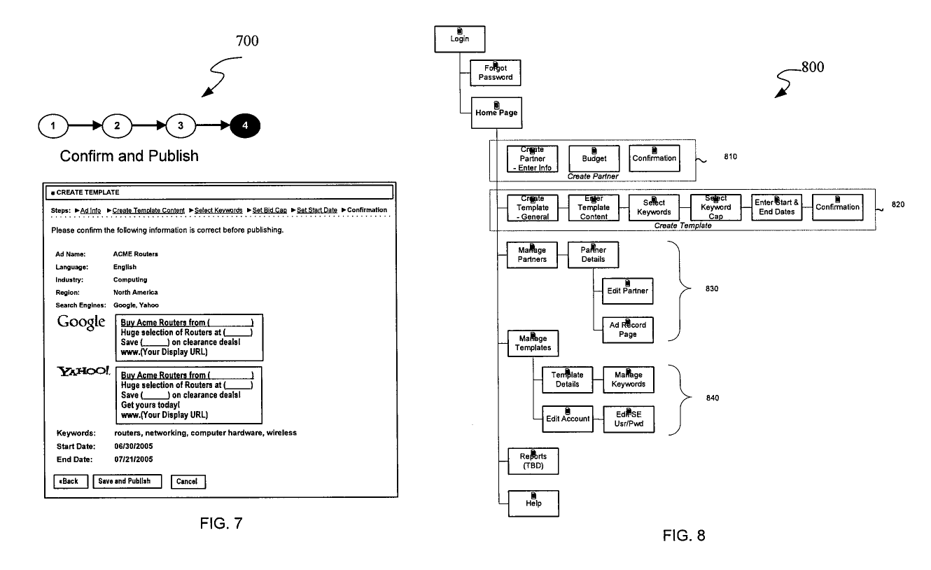

FIG. 7 depicts a screen shot of an exemplary user interface 700 summarizing the attributes (e.g., language, industry, region, name of advertisement) of the template. The enterprise may confirm, through the interface 700, the correctness of these parameters and the content of the advertisement. This confirmation is provided by selecting the “Save and Publish” button, upon which the SEM service provider 120 electronically publishes or otherwise makes available the completed template to the channel partners 114.

Turning now to FIG. 8, a hierarchical site map 800 is provided of the various user interfaces capable of being presented by the SEM service provider 120 to a business enterprise 118 during the process of creating advertising templates and other operations. As shown, a first sequence of interfaces 810 may be accessed by the business enterprise 118 in order to create an account associated with a given channel partner 114. A second sequence of interfaces 820 may also be accessed in order to create an advertising template in the manner described above with reference to FIGS. 4-7. An additional set of interfaces 830 may be generated by the SEM service provider 120 to facilitate management of the accounts corresponding to the channel partners 114 of the enterprise 118. Similarly, a plurality of interfaces 840 are provided to enable the business enterprise 118 to manage the set of advertising templates it has created for its channel partners 114.

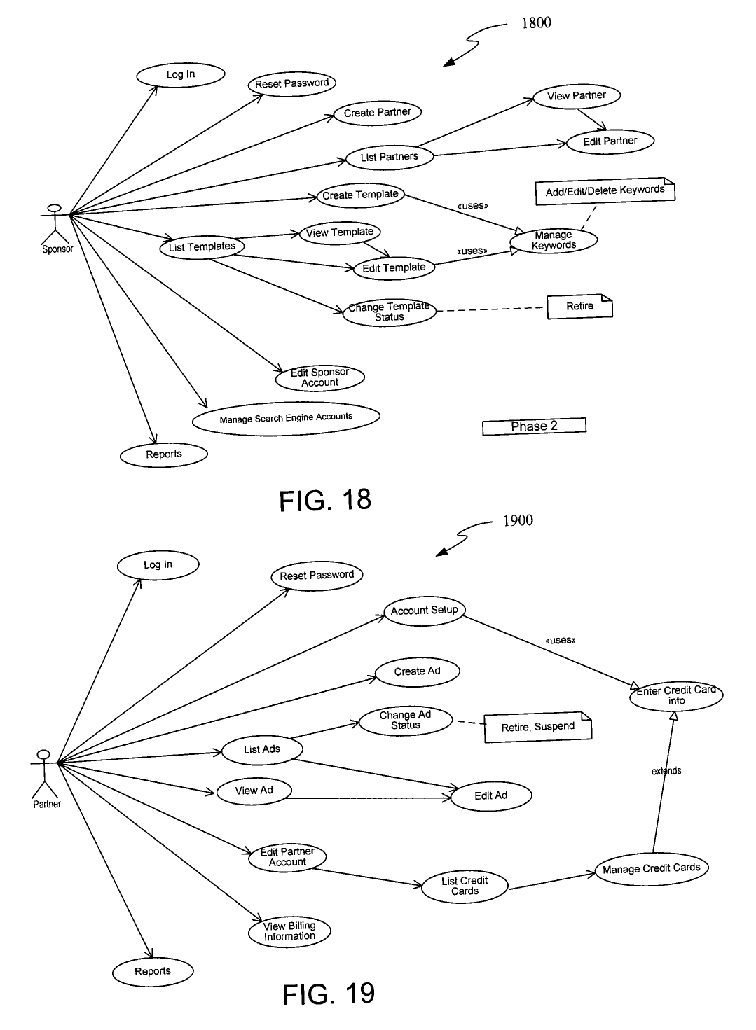

FIG. 18 illustrates a more generalized site map 1800 representative of those user interfaces which may be accessed by a business enterprise 118 in order to accomplish a variety of tasks relating to, for example, creation of partner and template definitions, viewing and editing of templates and lists of partners participating in various campaigns, and management of search engine accounts.

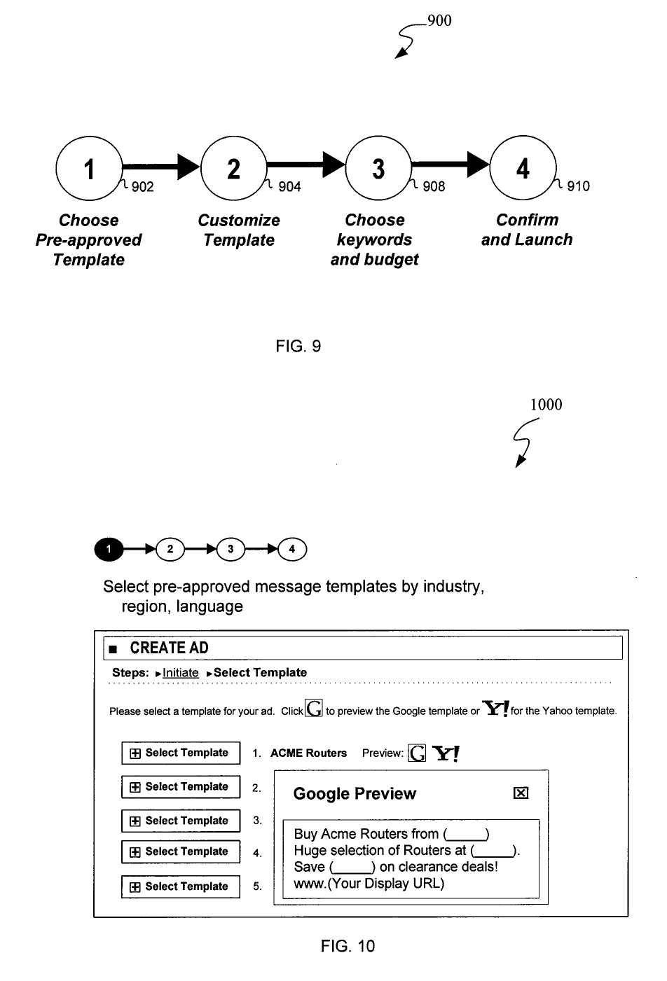

Turing now to FIG. 9, there is provided a flow chart 900 representative of an exemplary sequence of actions performed by a channel partner 114 in creating an advertisement based upon an advertising template defined by a business enterprise 118. In a stage 902, the channel partner 114 selects an advertising template that has been defined or approved by the business enterprise 118. The channel partner 114 then provides content for insertion into the reserved portions of the template that is unique to the channel partner or product being advertised (stage 904). Next, the channel partner 114 selects keywords processed by the applicable sponsored search applications which are desired to be bid upon, specifies a maximum bid for each selected keyword, and further specifies a budget (stage 908). At this stage the channel partner 114 may also select start/end dates during which the advertisement will run. In a stage 910, the completed advertisement is displayed to the channel partner 114 and the channel partner 114 provides confirmation that its content is correct. Once such confirmation is provided, the enterprise 118 launches the requested advertising campaign by providing information defining the completed advertisement to one or more of the search engines 108 for use by their respective sponsored search applications 126.

Although the embodiments described herein relate to the case in which a business enterprise 118 defines a template for use by its channel partners 114, in other embodiments it is contemplated that the advertisements created by the channel partners may be “free form” in nature and unconstrained by specific requirements of the sponsoring enterprise 118.

Attention is now directed to FIGS. 10-13, which illustrate a sequence of screen shots of exemplary graphical interfaces generated by the SEM service provider 120 through which a channel partner 114 may furnish the partner-specific information described above with reference to FIG. 9.

Turning now to FIG. 10, there is shown a screen shot of an exemplary graphical interface 1000 through which the channel partner 114 may select an advertising template previously approved and/or created by the business enterprise 118. In the exemplary embodiment these templates are, for example, generated for particular industries and geographical regions, thereby providing the channel partner 114 with a number of message options. As shown, the channel partner 114 may preview the appearance of each template with respect to its display by the sponsored search applications 126 of each search engine 108.

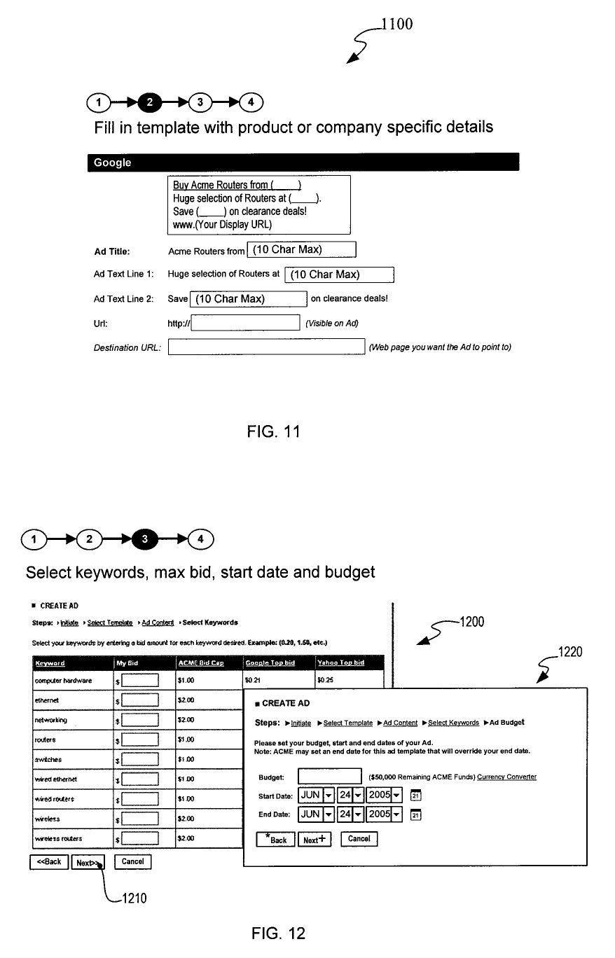

FIG. 11 shows a screen shot of an exemplary graphical user interface 1100 configured to accept customizing content from the channel partner 114 for insertion into appropriate portions of the selected template. As shown, in the exemplary embodiment the user interface 1100 includes a number of text boxes for receiving this customization content. A first text box, labeled “Ad Title:”, is provided for receiving identifying information from the channel partner 114 for insertion into the title of the advertisement created from the template. Other text boxes are provided for enabling the channel partner to enter customizing content for insertion into other portions of the advertisement. For example, the user interface 1100 affords the channel partner an opportunity to specify a uniform resource locator (URL) visible on the advertisement and a destination URL corresponding to the location of an actual Web page to be displayed upon selection of the visible URL.

Referring to FIG. 12, a screen shot of an exemplary user interface 1200 includes a column of text boxes under the heading “My Bid” through which the channel partner 114 may enter a bid associated with each of a list of keywords selected by the business enterprise 118 during development of the advertising template. The user interface 1200 displays, with respect to each keyword, maximum bids specified by the business enterprise and each search engine 108. Upon selecting the “Next” button 1210 via the interface 1200, an “Ad Budget” user interface 1220 is displayed. As shown, the interface 1220 includes a text box through which a budgetary amount associated with the advertisement may be entered. Drop-down boxes are also provided for specifying the start and end dates of the campaign involving the advertisement.

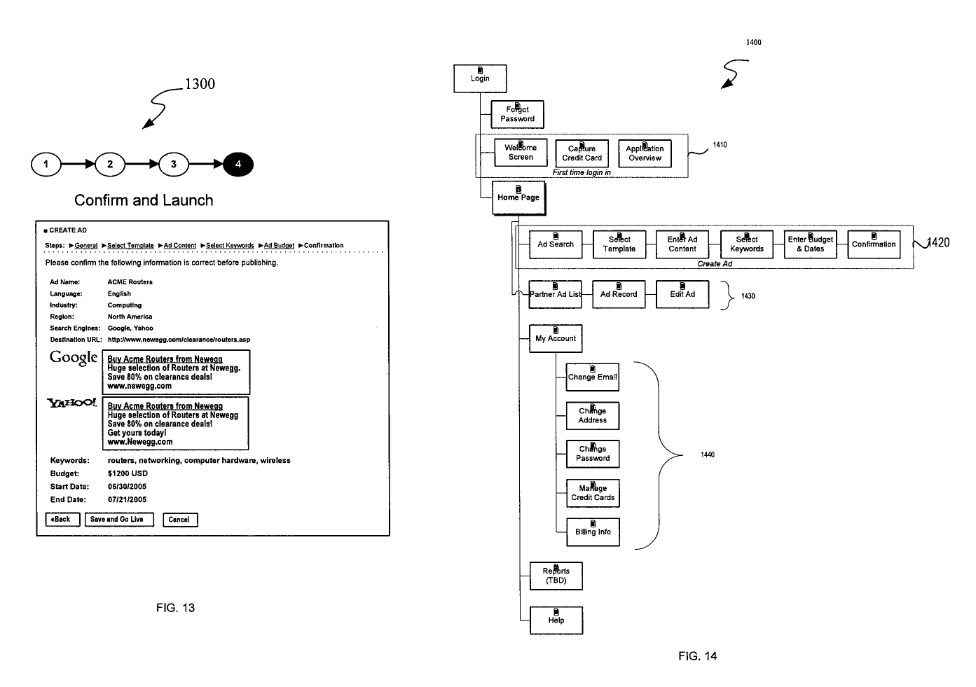

FIG. 13 depicts a screen shot of an exemplary user interface 1300 summarizing the details of a particular search engine advertising campaign developed in the manner described above with reference to FIGS. 4-12. In particular, the interface 1300 includes information for parameters such as “Ad Name”, “Language”, “Industry”, “Region”, the search engines 108 through which the campaign will be conducted, and a destination URL identifying a Web page to which viewers of the advertisement are directed upon selecting the URL visibly displayed within the advertisement. The interface 1300 also includes illustrations of the advertisement as it would be rendered within the sponsored search applications 126 of the selected search engines 108 (e.g., Google and Yahoo!). Finally, the interface 1300 indicates the keywords for which bids have been placed, and the budget and start/end date associated with the campaign. Once confirmation from the channel partner 114 is received through selection of the “Save and Go Live” button 1310, the SEM service provider 120 electronically provides information defining the campaign to the applicable search engines 108.

Turning now to FIG. 14, a hierarchical site map 1400 is provided of the various user interfaces capable of being presented by the SEM service provider 120 to a channel partner 114. As shown, a first sequence of interfaces 1410 may be accessed by a given channel partner 114 during an initial interaction with the SEM service provider 120. As discussed above with reference to FIGS. 10-13, a second sequence of interfaces 1420 may also be accessed by the channel partner 114 in order to create an advertisement using an advertising template generated by the SEM service provider 120 based upon information provided by the business enterprise 118. An additional set of interfaces 1430 enable the channel partner 114 to review a list of advertisements currently being managed by the SEM service provider 120 and to retrieve and edit records corresponding to such advertisements. As shown, another group of interfaces 1440 accessible to the channel partner 114 facilitate management of address, password and billing information associated with the account for the channel partner 114 maintained by the SEM service provider 120.

FIG. 19 illustrates a more generalized site map 1900 representative of those user interfaces which may be accessed by a channel partner 114 in order to accomplish a variety of tasks relating to, for example, setting up an account, creating, viewing and editing advertisements generated using a template(s) provided by a business enterprise 118, viewing and managing billing-related information, and generating reports.

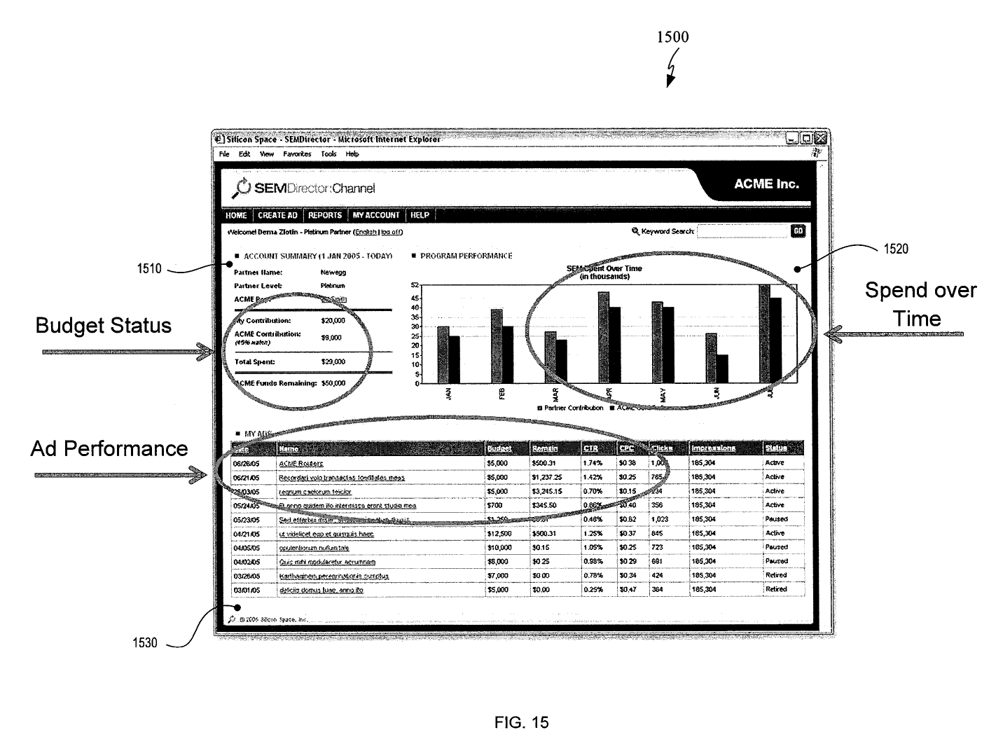

Attention is now directed to FIGS. 15-17, which depict screen shots of exemplary user interfaces generated by the SEM service provider 120 through which campaign status and performance information may be conveyed to a business enterprise 118 or one of its channel partners 114. One of skill in the art will appreciate that such information may be conveyed via a user interface, email or any other methods for effectively conveying the information. Email may also be used to alert a user (e.g., a business enterprise 118, a channel partner 114, etc.) as to whether performance goals have been met. One of skill in the art will also appreciate that each user can configure the information in a manner desirable to that user.

FIG. 15 provides a screen shot of an exemplary status and performance user interface 1500 accessible to a channel partner 114. As shown, the primary pane of the user interface 1500 is divided into an account summary sub-pane 1510, a program performance sub-pane 1520 and an ad performance sub-pane 1530. The account summary sub-pane 1510 may include, for example, information relating to the contribution of the channel partner 114 to advertising campaigns conducted with respect to goods or services of the business enterprise 118, the amount of matching contributions (if any) received by the channel partner 114 from the enterprise 118 in connection with such campaigns, an overall total spent on the campaigns, and the remaining amount of matching funds available to the channel partner 114. The program performance sub-pane 1520 generally provides a graphical representation of the relative contributions over time of the business enterprise 118 and channel partner 114 to advertising campaigns conducted by the channel partner 114 and sponsored by the business enterprise 118. Finally, the ad performance sub-pane 1530 provides an indication of the performance of individual advertising campaigns of the channel partner 114 in view of various metrics and other parameters. As is discussed below, the information relating to certain of these metrics (e.g., clicks, impressions) is provided to the SEM service provider 120 by the applicable search engines 108.

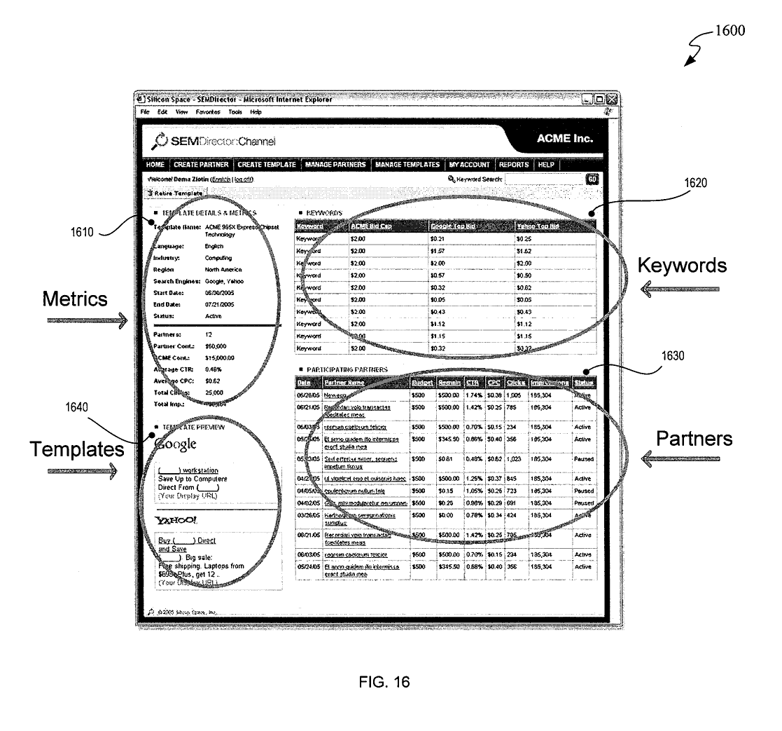

FIG. 16 provides a screen shot of an exemplary user interface 1600 through which a business enterprise 118 may receive status and other information relating to advertising campaign(s) involving a particular template. As shown, the interface 1600 includes a template details and metrics sub-pane 1610 providing various details regarding the applicable template. The keywords available to channel partners 114 for bidding in connection with potential placement of advertisements in the sponsored search applications 126 of participating search engines 108 are shown in a keywords sub-pane 1620. In addition, a list of channel partners 114 developing advertisements based upon the template is shown in a participating partners sub-pane 1630. Finally, preview representations of the template within the sponsored search applications of participating search engines 108 are displayed in a template preview sub-pane 1640.

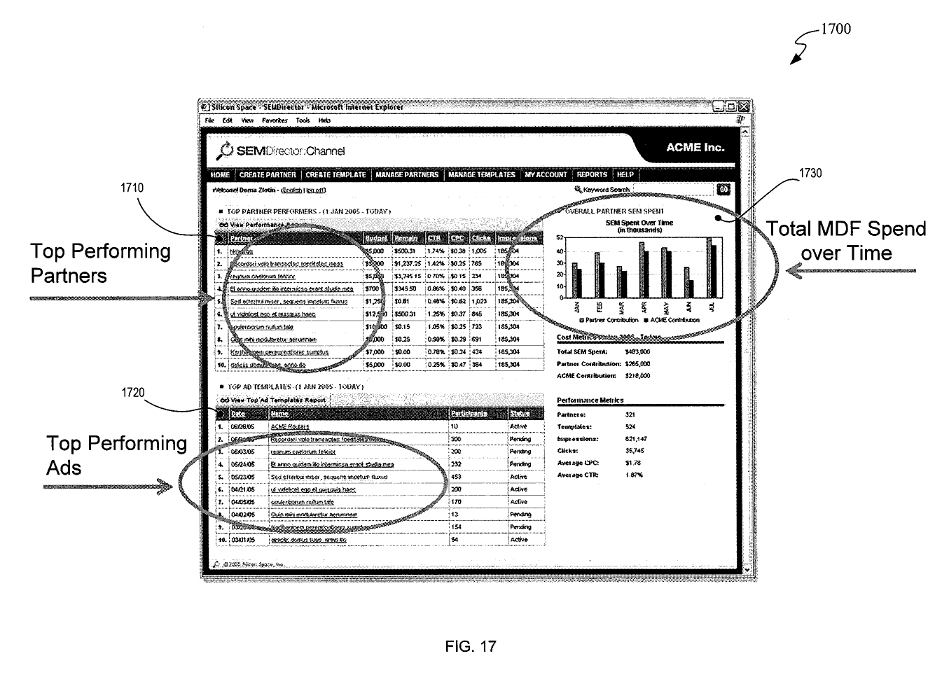

FIG. 17 depicts a screen shot of an exemplary user interface 1700 through which a business enterprise 118 may obtain overview information on various advertising campaigns involving its channel partners. As shown, the user interface 1700 includes a top partner performers sub-pane 1710, a top ad templates sub-pane 1720 and an overall partner SEM spent sub-pane 1730.

The SEM service provider 120 may also be implemented so as to include a business rules engine designed to be configurable, by either a channel partner 114 or enterprise 118, via user interfaces generated by the SEM service provider 120. Such configuration could, for example, enable the execution of specific actions or the sending of specific messages/alerts when defined conditions relating to keywords or campaigns have been met (e.g., campaign parameter limits have been exceeded or keyword-related triggering events have occurred). In particular embodiments rules could be established to mediate or arbitrate potential bidding or other conflicts relating to keywords which arise between channel partners or between a channel partner and a business enterprise. The SEM service provider 120 could also be configured to generate corresponding reports pertaining to such keyword-based or other conflicts.

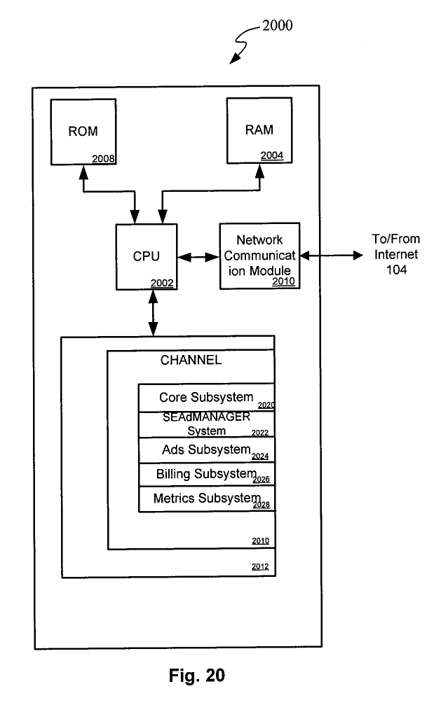

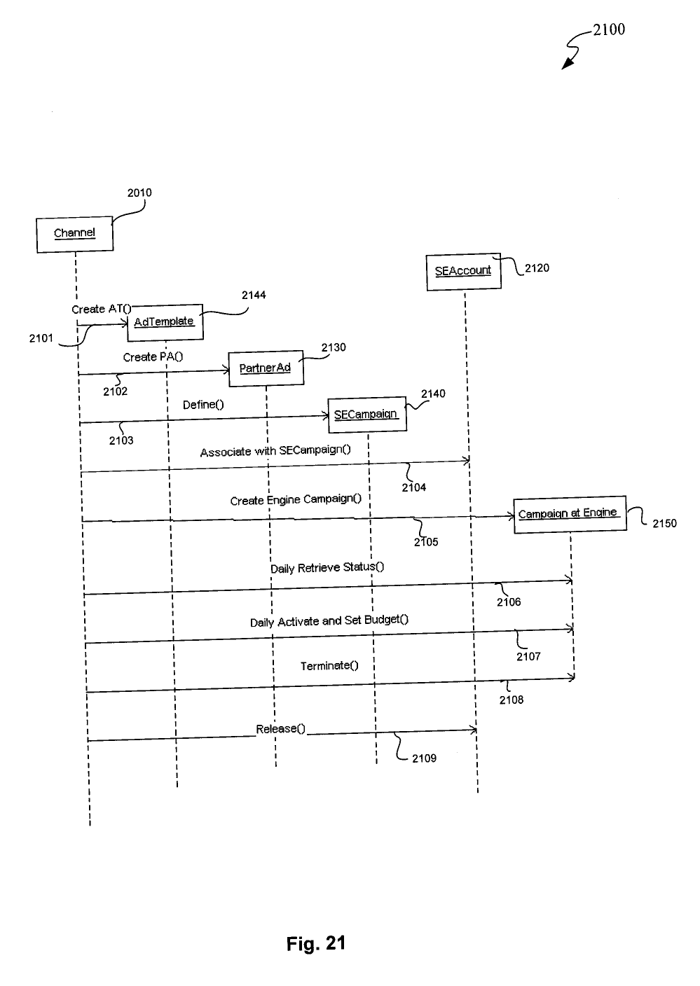

Attention is now directed to FIG. 20, which is a high-level diagram of exemplary server infrastructure 2000 operated by the SEM service provider 120. The server infrastructure 2000 includes a CPU 2002 connected to RAM 2004, ROM 2008, a network communication module 2010 and secondary data storage 2012. Included within secondary data storage 2012 are a Channel module 2010 comprised of a Core subsystem 2020, an SEAdManager subsystem 2022, an Ads subsystem 2024, a Billing subsystem 2026 and a Metrics subsystem 2028. The Channel module and its constituent subsystems, or simply the “Channel”, is intended to represent one or more software programs which, when executed by the CPU 2002, perform the operations described below with reference to FIG. 21 and otherwise disclosed herein. Secondary data storage 2012 also includes a copy of the operating system (not shown) executed by the CPU 2002. When effecting the functionality described below, the CPU 202 loads into RAM 204 and executes program instructions corresponding to one or more of the subsystems of the Channel module 2010.

Turning now to FIG. 21, there is illustrated a task flow diagram representative of the operations of the Channel 2010 with reference to the “lifespan” of an advertisement created by the SEM service provider 120 for a channel partner 114. Referring to FIG. 21, a search engine account (“SEAccount”) 2120 comprises a representation of the capability of the Channel module 2010 to run an authorized advertising campaign at a given search engine 108. In the exemplary embodiment one or more SEAccounts 2120 are associated with each channel partner 114 and a given search engine 108. Login credentials, a credit card, a daily budget, and some number of campaigns are typically associated with each SEAccount 2120. A SEAccount 2120 exists independently of an associated channel partner advertisement (“PartnerAd”) 2130, and may come in to existence before or after the PartnerAd 2130 is created. In the exemplary embodiment a SEAccount 2120 is associated with an applicable search engine campaign (“SECampaign”) 2140.

As shown, the lifespan of an advertisement effectively begins upon the creation, by a sponsoring business enterprise 118 via the Channel 2010, of an advertising template (“AdTemplate”) 2144 (stage 2101). Using the AdTemplate 2144, a channel partner 114 creates a “PartnerAd” 2130 via the Channel 2010 (stage 2102). The Channel 2010 then defines, upon definition of the PartnerAd by the applicable channel partner 114, a SECampaign 2140 for the sponsored search application 126 of each search engine 108 in which the PartnerAd 2130 will be run (stage 2103). The SECampaign 2140 will generally contain data that is not specific to any particular search engine 108 including, for example, daily budget and campaign duration information. However, the SECampaign 2140 also typically contains engine-specific CampaignData that describes how the PartnerAd 2130 will run on the sponsored search application 126 of a given search engine 108.

As shown, the Channel 2010 associates a SEAccount 2120 with a SECampaign 2140 (stage 2104). In the case of certain search engines 108, a SECampaign 2140 can only be associated with a single SEAccount 2120 at any given time. This is because such search engines 108 contemplate an “Account” concept that includes both daily budget and authority combined in a single object. In the case of other search engines, one SEAccount 2120 can be associated with multiple SECampaign 2140 because these search engines 108 separate the concept of budget (in the SECampaign) from authority (the SEAccount). If a SEAccount 2120 is not available for the given search engine 108, the Channel 2010 waits until a SEAccount 2120 becomes available before it proceeds. In the exemplary embodiment the channel partner 114 may at any time add additional SEAccounts 2120 to those associated with such partner. If a SEAccount 2120 is available at the time the PartnerAd 2130 is created, the association can occur immediately.

Referring again to FIG. 21, in a stage 2105 a Campaign at Engine 2150 is established using the associated SEAccount 2120 and the application programming interfaces (APIs) of the applicable search engines 108 (e.g., Google SOAP or Yahoo! DTC XML). In FIG. 21, it is assumed that creation of at least one Campaign at Engine 2150 is successful. If an SEAccount 2120 was associated when the applicable PartnerAd 2130 was created, the Campaign at Engine 2150 can also be established immediately; otherwise, such establishment occurs when the SEAccount 2120 becomes available. If upon creation of a SEAccount 2120 there exists a SECampaign 2140 waiting to be run at one or more search engines, the user may be given the option of specifying which SECampaign 2140 is to be run first.

Once a Campaign at Engine 2150 has been established, the applicable search engine 108 is typically polled on a daily basis in order to obtain information relating to the status of the campaign for reporting to the user (stage 2106). If the campaign has not yet been run, the Channel 2010 determines if the advertisement has been approved by the channel partner 114 and is otherwise ready to be run. The Channel 2010 also determines if there exist reasons why the advertisement may not yet have run (e.g., insufficient funds or expired credit card). The Channel 2010 also determines, on a daily basis, whether the advertisements for a given channel partner 114 should be run that day (stage 2107). This determination is based on, among other things: the budget remaining for the campaign, the campaign expiration date, the status of the credit card or other payment instrument being used and the amount of any payments due by the partner, the status of the partner, the status of the campaign, the status of the sponsor, and the presence of any campaign errors (as determined in stage 2106). For all those advertisements for which this determination indicates that the applicable advertisement should be run, the advertisement is then activated for the day at a given search engine and a corresponding daily budget is set. All other advertisements associated with the channel partner are deactivated, and the channel partner may be notified (e.g., via a user interface screen generated for the channel partner) that rectifying action may be required to be taken in order to allow these other advertisements to be activated. When the PartnerAd 2130 expires, the Campaign at Engine 2150 is terminated and deleted (stage 2108). The SEAccount 2120 is then disassociated from the SECampaign 2140 (stage 2109).

Daily activities and operations performed by an exemplary instantiation of the Channel 2010 may include, by way of example, gathering statistics on campaigns, gathering status on accounts (e.g., credit card expired), terminating and disassociating expired advertisements, associating and establishing any waiting advertisements, setting budgets, and activating the campaigns at a search engine for any campaign that could run that day (including suspended advertisements).

Asynchronous activities and operations performed by an exemplary instantiation of the Channel 2010 may include, by way of example, cancelling an advertisement, disassociating an SEAccount, activating a suspended advertisement, creating an account, setting a credit card, changing a bid, deactivating/reactivating individual keywords, and associating and establishing a waiting advertisement.

Although in the exemplary embodiment the activities described above will generally be performed either on a daily basis or asynchronously, in other implementations such activities may be performed in real-time or on a substantially real-time basis.

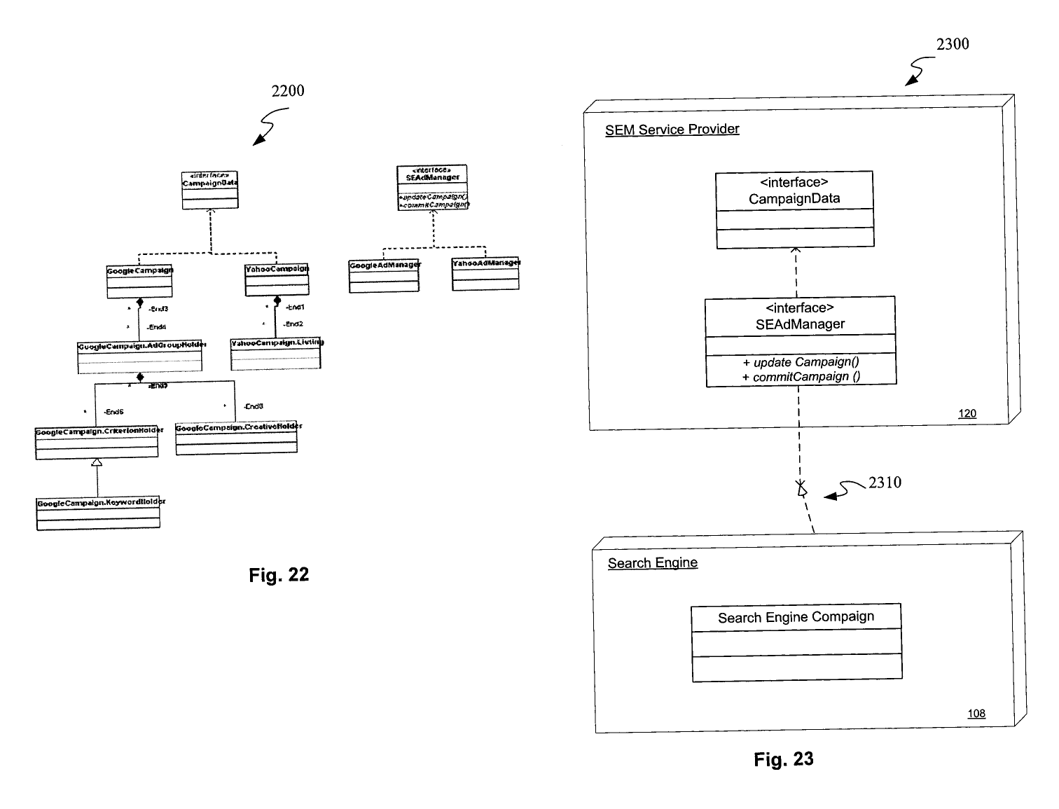

Referring now to FIG. 22, there is shown an exemplary class design of an object-oriented implementation of the SEAdManager subsystem 2022. In general, the SEAdManager subsystem 2022 functions to manage advertisements running concurrently at various search engines 108. The SEAdManager, via publicly accessible APIs of the search engines 108, creates and activates instances of advertisements, monitors the execution of these advertisements, and disables and deletes these advertisements.

As shown in FIG. 22, the exemplary class design of the SEAdManager subsystem 2022 includes a CampaignData element. In this exemplary class design the CampaignData element comprises an abstraction (and java interface) of both an ideal or “target” state and the last known state of a single advertising campaign being run at a single search engine 108. Because each search engine 108 is remote and not under the exclusive control the SEAdManager subsystem 2022, the actual state of the campaign at the search engine may, at any given time, differ from both of these states.

The class design of the SEAdManager subsystem 2022 represented by FIG. 22 further includes an SEAdManager element, which comprises an abstraction (and java interface) with two principal operations: updateCampaign and commitCampaign. The intent of these two methods is an implementation of a Concurrent Versions System (CVS) source code control update and commit pattern. In particular, the updateCampaign operation queries the applicable search engine 108 via its public APIs to determine the current state of a given campaign. This current state becomes the campaign's last known state. At any time, the last state can be compared to the target state to determine if the campaign is out of synchronization. The commitCampaign operation uses the public APIs of a search engine 108 to make changes to a given campaign at the search engine. This operation attempts to change the campaign at the search engine to synchronize the last state with the target state, but only makes changes that are necessary to bring the individual parts of the campaign into synchronization. This minimizes the number of calls to the APIs of the search engines 108, which has the benefit of reducing overall operation time and minimizing API usage costs. If the Channel is unable to successfully synchronize the target and last states of a campaign, a record of this failure, its cause, and any possible remedy is stored. The presence of any such record results in an “alert” displayed to the user, notifying the user of the problem and possible remedy.

As shown in FIG. 22, two implementations of the CampaignData interface specific to particular search engines 108 are represented: GoogleCampaign and YahooCampaign. In the exemplary embodiment the attributes of the GoogleCampaign interface match the data model of a Campaign as defined by Google. GoogleCampaigns may be comprised of one or more target AdGroups, zero or more “aberrant” AdGroups that exist for a campaign at Google and which are not target AdGroups, zero or more campaign-level target keywords, zero or more aberrant campaign-level keywords that exist in the campaign at Google and which are not target keywords, and a Google status indicating start and end dates, as well as a Google UID.

FIG. 22 depicts a number of other class elements associated with the GoogleCampaign interface, including the GoogleCampaign.AdGroupHolder, GoogleCampaign.CreativeHolder, and the GoogleCampaign.KeywordHolder.

The GoogleCampaign.AdGroupHolder stores the target and aberrant states of an AdGroup for a Campaign at Google. It may comprise of one or more target creatives (e.g., the CreativeHolder), zero or more aberrant creatives, one or more target keywords (e.g., the KeywordHolder), zero or more aberrant keywords, and Google status indicators (e.g., the date if deleted, a Google UID).

The GoogleCampaign.CreativeHolder stores the target state and the last state of a creative for a campaign at Google. It may comprise of target ad titles, ad texts, and ad URLs, last ad titles, ad texts, and ad URLs, and Google status indicators (e.g., the date if deleted, the date if approved, a Google UID).

The GoogleCampaign.KeywordHolder stores the target and last states of a keyword for a campaign at Google. It may comprise target keyword text, cost per click information, and indicators of “negative” status, last keyword text, cost per click information, and indicators of “negative” status, and Google status indicators (e.g., the date if deleted, a Google UID).

In the exemplary embodiment, the YahooCampaign comprises a Yahoo-specific implementation of the CampaignData interface. The attributes of the YahooCampaign match the data model of a Campaign at Yahoo. YahooCampaigns may be comprised of one or more target listings (e.g., a YahooCampaign.Listing), zero or more “aberrant” listings that exist for the campaign at Yahoo and which are not a target listing, zero or more target campaign-level excluded (i.e., negative) phrases, zero or more aberrant campaign-level excluded phrases that exist in the campaign at Yahoo and which are not target campaign-level excluded phrases, and Yahoo status indicators.

Associated with a YahooCampaign is a YahooCampaign.Listing, which stores the target and aberrant states of a Listing for a Campaign at Yahoo. In the exemplary embodiment a YahooCampaign.Listing may comprise a target keyword (e.g., text, cost per click, etc.), a target creative text (e.g., title, text, URL, etc.), a last keyword (e.g., text, cost per click, etc.), a last creative text (e.g., title, text, URL, etc.), and Yahoo status indicators (e.g., date deleted, Yahoo UID, online status, etc.).

In another embodiment, the last state and target state can each be stored as separate data structures but using the same data model. It can then be determined whether the two states are synchronized by determining whether the two data structures are equal.

As shown in FIG. 22, two implementations of the SEAdManager interface specific to the Google and Yahoo! search engines are represented: GoogleAdManager and YahooAdManager. The GoogleAdManager class is capable of utilizing the publicly available API of Google in order to update the GoogleCampaign with current state, as well as to synchronize the Campaign at Engine for Google to match the target state. Similarly, the YahooAdManager class is capable of utilizing the publicly available API of Yahoo! in order to update the YahooCampaign with current state, as well as to synchronize the Campaign at Engine for Yahoo to match the target state.

Attention is now directed to FIG. 23, which is a diagram 2300 representative of the communication occurring between the SEM service provider 120 and a search engine 108. In the case of the Google search engine, the Public API 2310 is implemented as a SOAP service. In the case of the Yahoo! search engine, the Public API 2310 is implemented as XML over HTTP. The SEAdManager implementation for the given search engine encapsulates information relating to the respective Public API.

As is indicated by FIG. 23, the Search Engine Campaign may be characterized as having its own state at the applicable search engine 108. Since the SEM service provider 120 is not in continuous communication with each search engine 108, the state of each Search Engine Campaign may change without the knowledge of the SEM service provider 120. Accordingly, the corresponding CampaignData element maintained by the SEM service provider 120 reflects this state only as of the time of receipt of the last updated state information from the search engine 108. Since the CampaignData element also knows the target state of the applicable campaign, it synchronizes the Campaign at Engine via the Public API 2310 to match this target state.

As was mentioned above, the Channel module 2010 is comprised of at least a core subsystem 2020, a SEAdManager subsystem 2022, an ads subsystem 2024, a billing subsystem 2026 and a metrics subsystem 2028. These subsystems are configured to implement the specific business logic of the Channel module. The core subsystem 2020 includes channel users, people, roles & privileges, partners, and sponsors. The ads subsystem 2024 includes collaboration between sponsors and partners in the creation of ads. The billing subsystem 2026 includes channel-specific billing. The metrics subsystem 2028 includes campaign and keyword metrics.

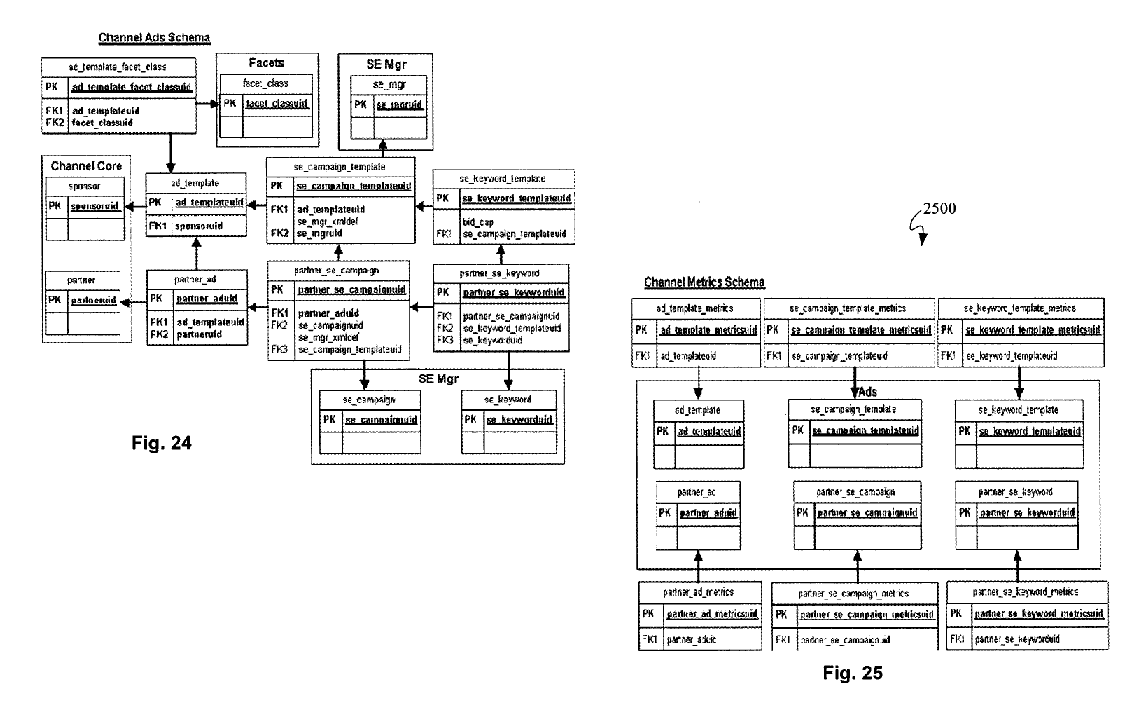

Turning now to FIG. 24, there is illustrated a Channel Ads Schema 2400 representative of an exemplary implementation of the Ads subsystem 2024. As indicated above, the Ads subsystem 2024 is disposed to manage the creation of advertisements through the collaboration of channel partners 114 and sponsoring business enterprises 118. The Channel Ads Schema 2400 includes an ad_template which defines of a generic ad campaign by a sponsoring business enterprise. Any number of channel partners may choose to implement the ad campaign (e.g., in the form of a partner_ad). The ad_template defines one or more se_creative_templates (e.g., ad text with wildcards) and one or more se_keyword_templates (e.g., keywords to be used by the partner_ad at a search engine and that have a bid_cap). The ad_template is classified with respect to zero or more facet class_identities via an ad_template facet_class_identity. The classification restricts which partners qualify to implement the ad_template. The se_campaign_template represents the ad text (e.g., title and description) that will display at a given search engine (e.g., SEMgr). The ad text can include wildcards (i.e., text slots that will be filled in by an implementing channel partner). The se_campaign_template may also contain, if specified by the sponsoring business enterprise, search engine-specific details such as Google geographic targeting. The se_keyword_template pertains to a keyword in the se_campaign_template, and provides a business-enterprise-specific bid_cap at a search engine. The partner_ad is an implementation of an ad_template by a channel partner. It may include partner-specific budgeting, but not search engine-specific budgeting. The partner_ad is associated with partner_se_campaigns that implement the se_campaign_templates and the se_keyword_templates associated with the ad template. The partner_se_campaign pertains to a search-engine-specific unit of daily budgeting. Depending on the search engine, it can contain one or more ad creatives and one or more keywords (e.g., encoded in se_mgr_xmldef). It corresponds to one se_campaign when the ad is running. The partner_se_keyword is an se_keyword_template with a max bid specific to the channel partner. The ad_template_facet_class is a classification of the ad_template. The classification restricts which channel partners qualify to implement the ad_template.

FIG. 25 illustrates a Channel Metrics Schema 2500 representative of an exemplary implementation of the Metrics subsystem 2028. As indicated above, the Metrics subsystem 2028 is disposed to store performance data relating to various campaigns and to the keywords relevant to such campaigns. The entities included with the Schema 2500 include ad_template_metrics (e.g., performance data on AdTemplates), se_campaign_template_metrics (e.g., performance data on SECampaignTemplates), se_keyword_template_metrics (e.g., performance data on SEKeywordTemplates), partner_ad_metrics (e.g., performance data on PartnerAds), partner_se_campaign_metrics (e.g., performance data on PartnerSECampaigns), and partner_se_keyword_metrics (e.g., performance data on PartnerSEKeywords).

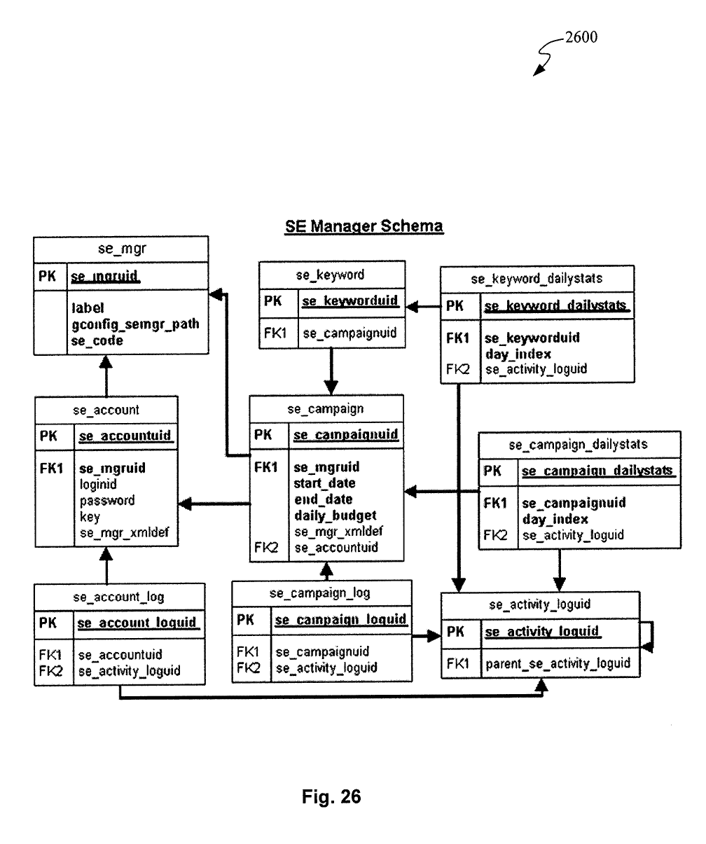

Referring now to FIG. 26, there is shown an SE Manager Schema 2600 representative of an exemplary implementation of the SEAdManager subsystem 2022. As indicated above, the SEAdManager subsystem 2022 is disposed to manage the running of advertisements at search engines 108. In an exemplary embodiment the SEAdManager subsystem 2022 is a “self-contained” subsystem in that it knows essentially nothing about the other subsystems of the Channel module 2010. One upshot of this design of the SEAdManager subsystem 2022 is that the SE Manager Schema 2600 implements an abstraction of the complexities of the different search engines 108 (i.e., information relating to specific attributes of the search engines 108 are not included within the SE Manager Schema 2600). Instead, specific data concerning the search engines 108 are preferably included within beans implementing CampaignData and AccountData, which are respectively stored within SECampaign and SEAccount. Of course, in other embodiments the SE Manager Schema 2600 may store information for a more complete model of the specific options associated with the various search engines 108. The entities comprising the SE Manager Schema 2600 include se_mgr, se_account, se_campaign, se_campaign_dailystats, se_keyword, se_keyword dailystats, se_campaign, se_account_log, and se_activity_log. The se_mgr represents one search engine. The implementation of a specific engine is governed by a definition within a GCongif.xml file and its implementing class. The se_account is an abstraction of the ability to manage one advertisement at a search engine. With respect to the Google and Yahoo! search engines, this entity corresponds to a Google Account or a Yahoo! Account. In the case of Yahoo!, an account can only manage a single se_ad at a time, which is a constraint implemented by the java search engine manager). In the case of Google, an account can manage an unlimited number of se_ads. The se_campaign is the daily budgeted amount of advertising to occur at a search engine. It is an abstraction of an advertisement campaign running at a given search engine. The se_mgr manages the se_campaign using the se_account. The se_campaign_dailystats corresponds to the statistics concerning the campaign for a given day. The se_keyword indicates one keyword in one campaign on which statistics can be collected. In the case that a keyword is used in multiple listings or multiple ad groups, the keywords are stored in one record and statistics are aggregated across the listings and/or ad groups. The se_keyword_dailystats corresponds to the statistics concerning a keyword for a given day. The se_campaign_log logs all information pertaining to communication with the search engine on behalf of the campaign. The se_account_log logs all information pertaining to communication with the search engine on behalf of the account. The se_activity_log logs activities that give rise to actions on the search engine. For example, a batch of daily updates may have an se_activity_log entry.

Accordingly, a system and method for facilitating cooperative search engine marketing among business entities and their respective channel partners has been described. Embodiments of the invention permit such business enterprises to drive channel sell-through by leveraging market development funds, and reduce overall advertising expenditures by sharing advertising costs with channel partners and by managing keyword bidding competition across channel partners. Moreover, embodiments of the inventive system and method may also promote brand integrity, ensure consistent messaging, and optimize the quality of traffic to the web sites of channel partners

The foregoing description, for purposes of explanation, used specific nomenclature to provide a thorough understanding of the invention. However, it will be apparent to one skilled in the art that the specific details are not required in order to practice the invention. In other instances, well-known circuits and devices are shown in block diagram form in order to avoid unnecessary distraction from the underlying invention. Thus, the foregoing descriptions of specific embodiments of the invention are presented for purposes of illustration and description. They are not intended to be exhaustive or to limit the invention to the precise forms disclosed, obviously many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated. It is intended that the following Claims and their equivalents define the scope of the invention.

What is claimed is:

1. A method for creating an advertisement for a channel partner of a business enterprise, the method comprising:
receiving, from the channel partner, a selection of at least one advertising template and at least one target, wherein the at least one advertising template and the at least one target are developed by the business enterprise;
receiving, from the channel partner, advertising information for inclusion within the advertisement consistent with the advertising template; and
receiving, from the channel partner, one or more constraints on a bid price for the at least one target, wherein the one or more constraints on the bid price are associated with the advertisement.

2. The method of claim 1, wherein the advertisement is created for inclusion within results produced by one or more sponsored search applications, and wherein the at least one target includes at least one keyword that is processed by the one or more sponsored search applications.

3. The method of claim 2, further comprising:
displaying a set of reports for both the channel partner and business enterprise to document advertising metrics and results.

4. The method of claim 2, wherein the at least one advertising template is selected by the channel partner from among plural advertising templates approved by the business enterprise.

5. The method of claim 4, wherein the plural advertising templates include a first plurality of advertising templates associated with a first search engine and a second plurality of advertising templates associated with a second search engine.

6. The method of claim 4, wherein the at least one advertising template may be selected from among the plural advertising templates by industry, region and language.

7. The method of claim 2, further comprising:
receiving, from the channel partner, a budget corresponding to the one or more constraints on the bid price for the available keyword.

8. The method of claim 2, further comprising:
receiving, from the channel partner, a start date and an end date defining a time period during which the advertisement may be placed among the results produced by the one or more sponsored search applications.

9. The method of claim 2, further comprising:
acquiring, from the one or more sponsored search applications, information relating to performance of the advertisement in connection with operation of the one or more sponsored search applications.

10. The method of claim 9, further comprising:
providing, to the channel partner, the information relating to performance of the advertisement.

11. The method of claim 9, further comprising:
providing, to the channel partner, status information pertaining to a budget associated with the advertisement.

12. The method of claim 2, further comprising:
receiving, from the channel partner, an indication of approval of the advertisement.

13. The method of claim 2, further comprising:
receiving, from the channel partner, a claim for reimbursement.

14. The method of claim 2, further comprising:
calculating a return of advertising spent (ROAS) of the business enterprise; and
determining, based on the ROAS of the business enterprise, an amount of marketing funds made available by the business enterprise to the channel partner.

15. The method of claim 1, wherein the advertisement is created for inclusion within a marketing campaign selected from the group consisting of a television marketing campaign, a radio marketing campaign, and a print media marketing campaign

16. The method of claim 1, wherein the advertisement is a text-based advertisement.

17. The method of claim 1, wherein the advertisement is a video-based advertisement.

18. The method of claim 1, wherein the advertisement is a image-based advertisement.

19. The method of claim 1, wherein the at least one target includes at least one demographic or geographic category.

20. The method of claim 1, wherein the at least one target includes at least one website URL.

21. A method for generating an advertising template capable of being utilized by a channel partner of a business enterprise to create an advertisement, the method comprising:
selecting one or more template attributes of the advertising template;
receiving, from the business enterprise, advertising content for incorporation into the advertising template consistent with the one or more template attributes of the advertising template;
receiving, from the business enterprise, one or more selections of one or more targets;
receiving, from the business enterprise, acceptable bid limits associated with the one or more targets;
incorporating the one or more selections of the one or more targets and the bid information into the advertising template; and
displaying, for the business enterprise, a representation of the advertising template.

22. The method of claim 1, wherein the advertisement pertains to one or more sponsored search applications, and wherein the one or more targets include at least one keyword that is processed by the one or more sponsored search applications.

23. The method of claim 22, wherein the advertising template is configured such that customization information received from the channel partner may be incorporated within the advertising template.

24. The method of claim 22, further comprising:
receiving, from the business enterprise, approval of the advertising template and electronically publishing, over a network, the advertising template to the channel partner of the business enterprise.

25. The method of claim 22, wherein the one or more template attributes pertain to one or more industries, regions, languages or search engines to which the advertisement will be provided.

26. The method of claim 22, wherein the bid information comprises a maximum allowable bid.

27. The method of claim 22, further comprising:
acquiring information from the one or more sponsored search applications relating to performance of the advertisement.

28. The method of claim 22, further comprising:
publishing the advertising template to a plurality of channel partners of the business enterprise.

29. The method of claim 26, further comprising:
receiving, from the plurality of channel partners, customization information for a corresponding plurality of advertisements generated using the advertising template.

30. The method of claim 29, further comprising:
acquiring information from the one or more search applications relating to performance of the plurality of advertisements.

31. The method of claim 29, further comprising:
calculating a return of advertising spent (ROAS) of the business enterprise; and
determining, based on the ROAS of the business enterprise, an amount of marketing funds made available by the business enterprise to the channel partner.

32. The method of claim 21, wherein the advertisement pertains to a marketing campaign selected from the group consisting of a television marketing campaign, a radio marketing campaign, and a print media marketing campaign

33. The method of claim 21, wherein the advertisement is a text-based advertisement.

34. The method of claim 21, wherein the advertisement is a video-based advertisement.

35. The method of claim 21, wherein the advertisement is a image-based advertisement.

36. The method of claim 21, wherein the one or more targets include at least one demographic or geographic category.

37. The method of claim 21, wherein the one or more targets include at least one website URL.

38. A server for managing network-based advertising conducted by a plurality of channel partners of a business enterprise, the server comprising:
at least one processor;
a network interface for receiving, from over a network, advertising performance information from at least one sponsored search application; and
a memory, operatively coupled to the processor, for storing logical instructions wherein execution of the logical instructions by the processor results in performing of operations, including:
generating an advertising template capable of being utilized by the plurality of channel partners of the business enterprise to create a corresponding plurality of advertisements; and
creating report information using the advertising performance information, wherein the advertising performance information is indicative of performance of the plurality of advertisements with respect to the at least one sponsored search application.

39. The server of claim 38, wherein a first portion of the report information is transmitted through the network interface and over the network to a facility of at least one of the plurality of channel partners.

40. The server of claim 39, wherein a second portion of the report information is transmitted through the network interface and over the network to a facility of the business enterprise.

41. The server of claim 38, wherein the performing of operations further includes:
tracking of usage, by the plurality of channel partners, of marketing funds made available by the business enterprise.

42. The server of claim 38, wherein the performing of operations further includes:
calculating a return of advertising spent (ROAS) of the business enterprise; and
determining, based on the ROAS of the business enterprise, an amount of marketing funds made available by the business enterprise to at least one of the plurality of channel partners.

43. The method of claim 1, wherein the one or more constraints on the bid price include a maximum bid level.

44. The method of claim 1, wherein the one or more constraints on the bid price include a value of market development funds assigned to the channel partner by the business enterprise.
